(19) United States
(12) Patent Application Publication
(10) Pub. No.: US 2020/0311725 A1
(43) Pub. Date: Oct. 1, 2020

(54) SECURE COMMUNICATION

(71) Applicant: Nokia Technologies Oy, Espoo (FI)

(72) Inventor: Teemu Ilmari SAVOLAINEN, Nokia (FI)

(73) Assignee: Nokia Technologies Oy, Espoo (FI)

(21) Appl. No.: 15/780,995

(22) PCT Filed: Dec. 23, 2015
(86) PCT No.: PCT/FI2015/050943

§ 371 Date: Jun. 1, 2018

(51) Int. Cl. G06Q 20/38; G06Q 20/40; H04L 9/08; H04L 9/32

(52) U.S. Cl. CPC G06Q 20/3829; G06Q 20/401; G06Q 20/3821; G06Q 2220/00; H04L 9/3239; H04L 2209/56; H04L 9/0825

(57) ABSTRACT

According to an example aspect of the present invention, there is provided an apparatus comprising memory configured to store a measurement device identifier, and at least one processing core configured to compile a measurement request, the measurement request comprising the measurement device identifier, a public key of the apparatus and cryptographic payment information, to cause transmission of the measurement request, and to decrypt measurement data using a private key of the apparatus.

### FIELD

The present invention relates to secured communication, such as secured communication of personal information.

### BACKGROUND

Personal information, such as medical, political or other user-specific information, must be handled confidentially to ensure persons are not victimized by hackers, identity thieves or spies, for example. Personal information may be kept in confidence by placing it in locked compartments, for example at doctors' offices. Furthermore, banks employ access controls and cryptography to secure banking information and online transactions, respectively. Email correspondence may be secured using cryptography, such as public-key cryptography, for example.

In a distributed model, management of information as well as securing information and payments may need to all be handled. In distributed systems, information may need to be replicated from one node to another to make it accessible, yet replicating to new nodes creates security challenges as the broader the set of nodes storing the information, the more targets an attacker will have should she wish to steal the information. Examples of distributed models include peer-to-peer, mesh and Internet of Things, IoT, models.

In a distributed model, management of cryptographic keys likewise presents challenges, since the keys must be kept secured, yet still be available to authorized entities to perform decryption. Payment processing, if performed in a distributed system, may rely on a network of trust, for example, where verified user accounts are used to effect payments between explicitly or implicitly trusted entities.

Cryptocurrencies present one payment methodology in distributed systems. Cryptocurrencies form a subset of digital currencies, with Bitcoin being the most widely used decentralized cryptocurrency. While many cryptocurrency specifications are in existence, many are derivatives of the Bitcoin specification. A decentralized cryptocurrency is produced by the system employing the cryptocurrency collectively. Most cryptocurrencies are pseudo-anonymous in that cryptocurrency holders may be able to maintain their anonymity with respect to each other when conducting cryptocurrency transactions.

### SUMMARY OF THE INVENTION

The invention is defined by the features of the independent claims. Some specific embodiments are defined in the dependent claims.

According to a first aspect of the present invention, there is provided an apparatus comprising memory configured to store a measurement device identifier, and at least one processing core configured to compile a measurement request, the measurement request comprising the measurement device identifier, a public key of the apparatus and cryptographic payment information, to cause transmission of the measurement request, and to decrypt measurement data using a private key of the apparatus.

Various embodiments of the first aspect may comprise at least one feature from the following bulleted list:
the at least one processing core is configured to decrypt the measurement data by decrypting a symmetric key using the private key, and then decrypting the measurement data using the symmetric key
the public key of the apparatus comprises at least one of a source address or public address associated with the apparatus
the apparatus is configured to receive the symmetric key, in encrypted form, together with the measurement data
the apparatus is configured to cause transmission of the measurement request to a payment processor distinct from the measurement device
the apparatus is configured to cause transmission of the measurement request to the measurement device
the apparatus is configured to receive the measurement data from the measurement device
the apparatus is configured to obtain a hash value based at least partly on a secret value, the cryptographic payment information comprises a pointer to a payment transaction and wherein the measurement request comprises the secret value
the apparatus is configured to inform a counterparty of the hash value in connection with participating in the payment transaction
the payment transaction comprises an escrow payment transaction, a reserve payment transaction or a provisional payment transaction.

According to a second aspect of the present invention, there is provided an apparatus comprising at least one processing core, at least one memory including computer program code, the at least one memory and the computer program code being configured to, with the at least one processing core, cause the apparatus at least to process a measurement request received in the apparatus, the measurement request comprising a public key of a node, a pointer to a payment transaction, and a secret value, verify the payment transaction using the secret value and the pointer, obtain measurement data by performing a measurement, and cause transmission of measurement data, encrypted using the public key, to the node.

Various embodiments of the second aspect may comprise at least one feature from the following bulleted list:
the apparatus is configured to receive an indication concerning a quota of measurement data associated with the payment transaction, and to stop obtaining the measurement data responsive to the quota being used up
the apparatus is configured to provide an indication concerning the quota being used up to a payment processor entity.

According to a third aspect of the present invention, there is provided a method comprising compiling a measurement request, the measurement request comprising a measurement device identifier, a public key of an apparatus and cryptographic payment information, causing transmission of the measurement request, and decrypting measurement data using a private key of the apparatus.

Various embodiments of the third aspect may comprise at least one feature corresponding to a feature from the preceding bulleted list laid out in connection with the first aspect.

According to a fourth aspect of the present invention, there is provided a method comprising processing a measurement request received in an apparatus, the measurement request comprising a public key of a node, a pointer to a payment transaction, and a secret value, verifying the payment transaction using the secret value and the pointer, obtaining measurement data by performing a measurement, and causing transmission of measurement data, encrypted using the public key, to the node.

Various embodiments of the fourth aspect may comprise at least one feature corresponding to a feature from the preceding bulleted list laid out in connection with the second aspect.

According to a fifth aspect of the present invention, there is provided an apparatus comprising means for compiling a measurement request, the measurement request comprising a measurement device identifier, a public key of an apparatus and cryptographic payment information, means for causing transmission of the measurement request, and means for decrypting measurement data using a private key of the apparatus.

According to a sixth aspect of the present invention, there is provided an apparatus comprising means for processing a measurement request received in an apparatus, the measurement request comprising a public key of a node, a pointer to a payment transaction, and a secret value, means for verifying the payment transaction using the secret value and the pointer, means for obtaining measurement data by performing a measurement, and means for causing transmission of measurement data, encrypted using the public key, to the node.

According to a seventh aspect of the present invention, there is provided a non-transitory computer readable medium having stored thereon a set of computer readable instructions that, when executed by at least one processor, cause an apparatus to at least compile a measurement request, the measurement request comprising a measurement device identifier, a public key of an apparatus and cryptographic payment information, cause transmission of the measurement request, and decrypt measurement data using a private key of the apparatus.

According to an eighth aspect of the present invention, there is provided a non-transitory computer readable medium having stored thereon a set of computer readable instructions that, when executed by at least one processor, cause an apparatus to at least process a measurement request received in an apparatus, the measurement request comprising a public key of a node, a pointer to a payment transaction, and a secret value, verify the payment transaction using the secret value and the pointer, obtain measurement data by performing a measurement, and cause transmission of measurement data, encrypted using the public key, to the node.

According to a ninth aspect of the present invention, there is provided an apparatus, comprising a memory configured to store a measurement device identifier, and at least one processing core configured to process a measurement request, received in the apparatus, the processing comprising validating, at least partly, a payment transaction, and to cause transmission to the measurement device of the measurement request, at least in part, wherein the received measurement request comprises the measurement device identifier, a public key of a requesting device and cryptographic payment information.

According to a tenth aspect of the present invention, there is provided a method, comprising storing a measurement device identifier, processing a measurement request, received in an apparatus, the processing comprising validating, at least partly, a payment transaction, and causing transmission to the measurement device of the measurement request, at least in part, wherein the received measurement request comprises the measurement device identifier, a public key of a requesting device and cryptographic payment information.

According to an eleventh aspect of the present invention, there is provided a non-transitory computer readable medium having stored thereon a set of computer readable instructions that, when executed by at least one processor, cause an apparatus to at least store a measurement device identifier, process a measurement request, received in the apparatus, the processing comprising validating, at least partly, a payment transaction, and to cause transmission to the measurement device of the measurement request, at least in part, wherein the received measurement request comprises the measurement device identifier, a public key of a requesting device and cryptographic payment information.

According to an twelfth aspect of the present invention, there is provided an apparatus, comprising means for storing a measurement device identifier, means for processing a measurement request, received in the apparatus, the processing comprising validating, at least partly, a payment transaction, and means for causing transmission to the measurement device of the measurement request, at least in part, wherein the received measurement request comprises the measurement device identifier, a public key of a requesting device and cryptographic payment information.

According to an thirteenth aspect of the present invention, there is provided a computer program configured to cause a method in accordance with at least one of the third, fourth or tenth aspects to be performed.

### BRIEF DESCRIPTION OF THE DRAWINGS

FIG. 1 illustrates an example system in accordance with at least some embodiments of the present invention;

FIG. 2 illustrates an example system in accordance with at least some embodiments of the present invention;

FIG. 3 illustrates an example apparatus capable of supporting at least some embodiments of the present invention;

FIG. 4 illustrates signalling in accordance with at least some embodiments of the present invention;

FIG. 5 illustrates signalling in accordance with at least some embodiments of the present invention.

FIG. 6 illustrates signalling in accordance with at least some embodiments of the present invention.

FIG. 7 illustrates signalling in accordance with at least some embodiments of the present invention.

FIG. 8 illustrates signalling in accordance with at least some embodiments of the present invention.

FIG. 9 illustrates signalling in accordance with at least some embodiments of the present invention.

FIG. 10 illustrates signalling in accordance with at least some embodiments of the present invention;

FIG. 11 is a flow graph of a method in accordance with at least some embodiments of the present invention, and

FIG. 12 is a flow graph of a method in accordance with at least some embodiments of the present invention.

### EMBODIMENTS

One way to perform delivery of encrypted content to a rightful owner is to provide encryption keying material, such as for example a public key, in connection with a payment for the content. For example, a public key may be delivered in a cryptocurrency payment transaction, which provides the benefit that the key is thus strongly associated with the entity requesting the content. The entity requesting content may remain anonymous, depending on the embodiment. The keying material may be provided inside a payment transaction protocol context, or with a pointer to the payment transaction, for example.

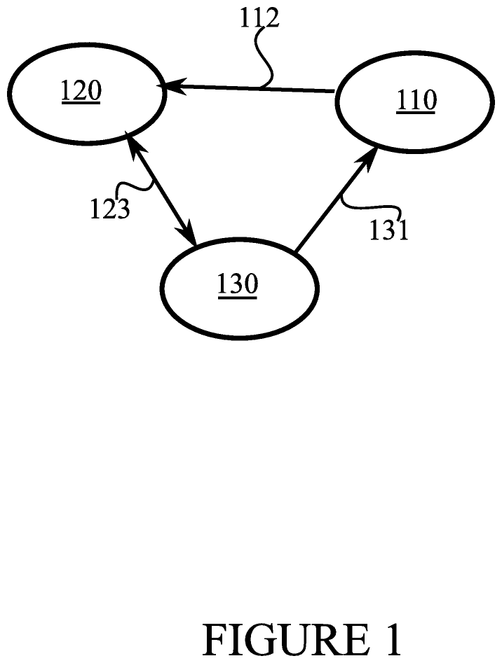

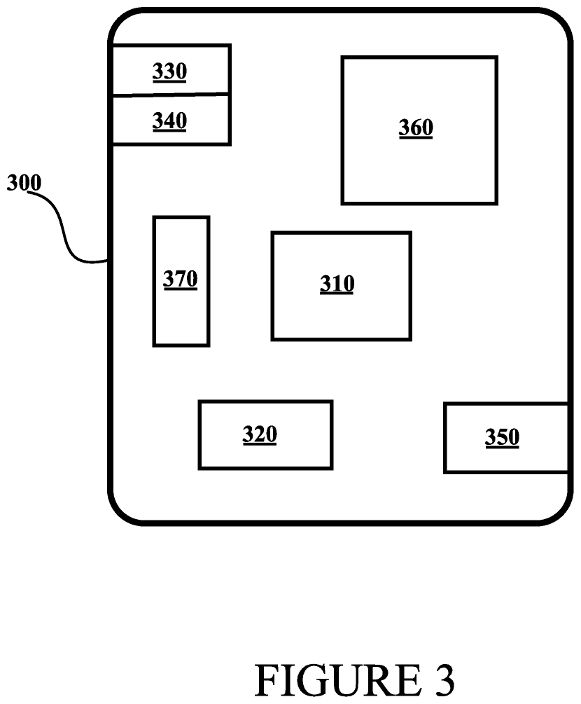

FIG. 1 illustrates an example system in accordance with at least some embodiments of the present invention. The figure illustrates device 110, which may comprise a user device, for example. Device 110 may comprise a smartphone, tablet computer, laptop computer, desktop computer, an item of smart jewellery or another kind of suitable device, such as a smart wallet device, for example. Device 110 may be furnished with a subscription specific to a user and/or at least one set of payment credentials. Payment credentials may comprise a secret value or function usable in ensuring a payment effected via the credentials is performed by the user and not by an unauthorized person. Payment credentials may comprise a credit card number or information stored in a secure payment chip, for example. Payment credentials may comprise a cryptocurrency wallet. Device 110 may be enabled to communicate, for example via near field communication, NFC, technology. Alternatively or additionally, device 110 may be configured to communicate using a cellular or non-cellular communication technology. Examples of cellular technologies include wideband code division multiple access, WCDMA, and long term evolution, LTE. Examples of non-cellular communication technologies include worldwide interoperability for microwave access, WiMAX, wireless local area network, WLAN, Bluetooth or Bluetooth Low Energy, IEEE 802.15.4, ZigBee, WirelessHART, ISA 100.11a, and Wireless USB. Device 110 may comprise an IoT device. Structure of device 110 is illustrated in FIG. 3, which will be described hereinbelow. Examples of communication protocols that may be used over the cellular and/or non-cellular communication technologies include IP, IP version 6, universal datagram protocol, UDP, transmission control protocol, TCP, datagram transport layer security, DTLS, transport layer security, TLS, constrained application protocol, CoAP, hypertext transfer protocol, HTTP, message queue telemetry transport, MQTT, and Bluetooth generic attribute protocol, GATT.

The system of FIG. 1 further comprises server 120, which may correspond to a service provider. For example, server 120 may be configured to facilitate measurement data processing by a measurement device 130. Server 120 may be based on generic computer hardware, such as the x86 or ARM architectures, for example. Server 120 may comprise, or be enable to communicate with, a payment function. The payment function may comprise a credit card processor or cryptocurrency processing function. Examples of cryptocurrencies include Bitcoin and Dogecoin.

Server 120 may be configured to, responsive to signalling from device 110, instruct measurement device 130 to provide measurement data to device 110. Measurement device 130 may comprise, or have access to, a sensor device. The sensor device may comprise a sensor, the sensor being configured to perform a measurement concerning a physical property, such as, for example, oxygen saturation in blood, electrical activity of heart using electrocardiography, ECG, volumetric measurement of an organ using photoplethysmogram, PPG, respiratory rate, posture or movement of person or object, location including geolocation using GPS, a hormone level, temperature, humidity, electric current or magnetic flux density. The measurement may comprise obtaining a time series of measurement values. A time series may enable determining a pattern such as a heart rate, electroencephalograph or breathing rate, for example. The time series may enable performing a determination concerning the pattern, such as, for example, whether a heart is in sinus rhythm or whether the heart is in tachycardia. The measurement data may comprise medical information relating to a user of device 110, for example, the measurement data may originate in a sensor applied to, or into, the user. The measurement data may thus comprise user-specific sensitive information.

Interface 112 connects device 110 to server 120. This interface may comprise a NFC interface, or, where applicable, device 110 may communicate with server 120 via a protocol connection traversing a wireless link, backhaul network and the Internet, for example. Interface 123 connects server 120 to measurement device 130. Like interface 112, this interface may comprise a NFC interface or, where applicable, a protocol connection traversing intermediate nodes. An example of a suitable protocol is internet protocol, IP. Interface 131, between measurement device 130 and device 110, may likewise comprise a short-range, such as NFC, interface or a protocol connection that traverses at least one network. In case measurement device 130 and device 110 are close to each other, interface 131 may comprise a short-range connection, such as NFC or Bluetooth. Server 120 may be in a remote location with respect to device 110 and measurement device 130. Measurement data may be delivered over interface 131, or, alternatively, measurement data may be delivered from measurement device 130 to a cloud storage and device 110 informed, over interface 131, of the storage of the measurement data to the cloud storage.

Once measurement data is obtained by measurement device 130, for example by performing a sensor measurement, it may be provided to device 110. Since the measurement data may comprise user-specific, personal information, it may be encrypted for delivery to device 110. Where interface 131 is encrypted, the measurement data is inherently protected during transit, but, for example, the Bluetooth protocol is not seen as offering reliable information security on its own, wherefore encryption of the measurement data itself, prior to transmission from measurement device 130, is preferred. Furthermore, in case the measurement data is provided to device 110 by storing the measurement data into a cloud service, the cloud service provider will have access to the data while it is stored therein, unless the data itself is encrypted.

Device 110 may store in a memory internal to device 110, or otherwise accessible to device 110, a key pair, the key pair comprising a private key and a public key in accordance with a public key cryptography cryptosystem. Examples of such cryptosystems include RSA and ElGamal. The public key is usable in encrypting but not decrypting, in other words, the public key is not capable of reversing the encryption it performs, and the public key may be freely provided to various parties without compromising security. The public key may, optionally, comprise or be comprised in a source address or other public address associated with device 110. A source address may comprise a source IP address, for example. The source or other public address may comprise a cryptocurrency address, account or identity, for example.

Device 110 may obtain an identifier of measurement device 130. For example, a user of device 110 may tap measurement device 130 with device 110, thereby triggering obtaining of the identifier over a NFC or Bluetooth connection. Alternatively, device 110 may capture the identifier from a surface of measurement device 130 by reading a barcode or 2-dimensional barcode, or indeed printed text, using an optical sensor of device 110. For example, where device 110 is a smartphone, the optical sensor may be comprised in a camera of device 110. The identifier of measurement device 130 may comprise an IP address, such as an IP version 6 address, or another kind of suitable identifier. The identifier may comprise a payment address, such as, for example, a cryptocurrency wallet address.

Device 110 may be configured to provide the public key to server 120 in connection with requesting measurement data. For example, device 110 may provide the public key and indicate the identifier of measurement device 130 in a measurement request transmitted to server 120. The measurement request may comprise one or two distinct messages, for example. The measurement request may be transmitted over a protocol connection between device 110 and server 120. Such a protocol connection may comprise a protocol connection in accordance with an electronic payment transaction specification, such as a cryptocurrency specification, which may offer a high level of security, which enables linking the public key with high confidence with any payment that is performed via the protocol connection. At least one measurement request message may be transmitted from device 110 to server 120 via the protocol connection. While described here as distinct devices, in some implementations server 120 and measurement device 130 may be physically in a same device, wherein server 120 and measurement device 130 may be functionalities of this same device.

Server 120 may process a measurement request received, in server 120, from device 110. For example, where the measurement request is connected with a payment, the payment may be validated by checking, if sufficient funds have been assigned. Such checking may comprise a credit card account check or a check relating to a cryptocurrency, for example. The payment may be provisional, escrow or reserve, meaning the payment is not finalized when initially validated. Where the check indicates the payment is validated, server 120 may provide the measurement request, at least partly, to measurement device 130. Server 120 may provide to measurement device 130 a specification concerning the measurement to be made, such as, for example, a duration of the measurement or a number of samples to capture. Where measurement device 130 comprises plural sensors, server 120 or device 110 may indicate to measurement device 130, which sensor the request relates to. Server 120 may also provide the public key to measurement device 130. In some embodiments, server 120 is configured to reserve the amount of the payment in a credit or currency account of the user of device 110, but not complete the charging before a further event occurs, such as for example the measurement data being delivered to device 110.

Measurement device 130 performs the requested measurement, or accesses from a memory already obtained measurement data matching the request. Measurement device 130 may then encrypt the measurement data using the public key of device 110. This encrypting may comprise encrypting the measurement data with the public key directly, or the encrypting may comprise generating a symmetric encryption key, encrypting the measurement data with the symmetric key, and then encrypting the symmetric key with the public key of device 110. In case a symmetric key is employed, it may be provided to device 110, in encrypted form, along with the encrypted measurement data. Examples of symmetric encryption algorithms include AES and 3DES. Measurement device 130 may inform server 120, or another node, once it has delivered the encrypted measurement data to device 110. Responsive to that informing, the payment may be completed in case it was only a reserve, provisional or escrow payment originally.

Once in possession of the encrypted measurement data, device 110 may decrypt it, either directly using the private key of device 110, or by using the private key the decrypt the symmetric key and then decrypting the measurement data with the decrypted symmetric key.

By delivering the public key in connection with the measurement request, for example in a payment transaction protocol connection, the measurement data may be delivered in a way that is securely accessible only to device 110, which requested the measurement. The measurement data is thus secure both during transmission to device 110, and, where applicable, in a cloud storage where device 110 may access the measurement data from. In case cloud storage is used, device 110 may in connection with the requesting provide a cloud storage address, where the encrypted measurement data is to be delivered.

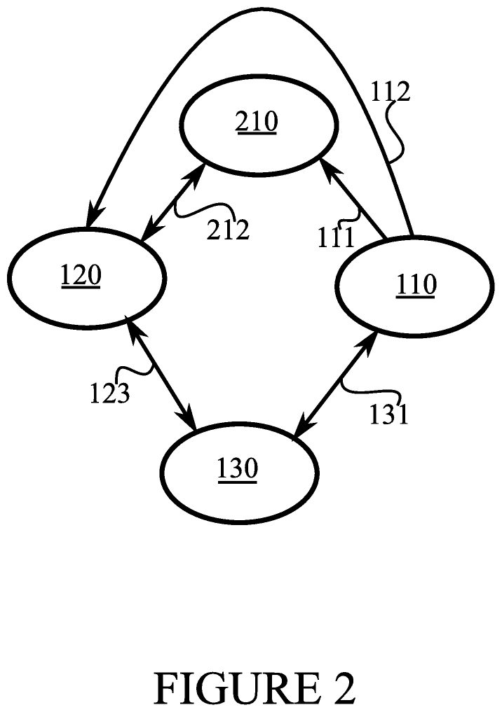

FIG. 2 illustrates an example system in accordance with at least some embodiments of the present invention. Like numbering denotes like structure as in FIG. 1. In addition to the nodes present in FIG. 1, FIG. 2 further illustrates payment processor 210. Device 110 has an interface 111 with payment processor 210, and payment processor 210 has an interface 212 with server 120. Interfaces 111 and 212 may comprise networked protocol interfaces, for example, such as IP, HTTP or HTTPS connections. Payment processor 210 implements a payment function, which, as described above, may comprise a credit card processor or cryptocurrency processing function, for example.

In FIG. 2, device 110 may first perform a payment transaction, such as a provisional, escrow or reserve transaction, with payment processor 210, using payment information, via interface 111, and then complete the measurement request by signalling to server 120 via interface 112, wherein when requesting the measurement from server 120 a pointer to the payment transaction may be provided. Server 120 may check, or validate, that the payment transaction exists via interface 212 prior to instructing measurement device 130 to perform the measurement, and provide the encrypted measurement data to device 110 as described in connection with FIG. 1. In other words, the measurement request transmitted from device 110 may comprise two messages, one to payment processor 210 and another message to server 120.

In some implementations in accordance with FIG. 2, measurement device 130 indicates to server 120 when the measurements are completed, responsive to which server 120 may close the payment transaction. Closing the payment transaction may comprise completing payment where the payment originally was tentative, escrow or reserve. While described herein as a provisional, reserve or escrow payment transaction, in some embodiments of the invention the payment transaction is in fact completed prior to the measurements being requested, by server 120, from measurement device 130.

FIG. 3 illustrates an example apparatus capable of supporting at least some embodiments of the present invention. Illustrated is device 300, which may comprise, for example, a mobile communication device such as device 110 of FIG. 1 or FIG. 2. Suitable structure illustrated in FIG. 3 may also be comprised in server 120 and/or measurement device 130. Comprised in device 300 is processor 310, which may comprise, for example, a single- or multi-core processor wherein a single-core processor comprises one processing core and a multi-core processor comprises more than one processing core. Processor 310 may comprise more than one processor. A processing core may comprise, for example, a Cortex-A8 processing core manufactured by ARM Holdings or a Steamroller processing core produced by Advanced Micro Devices Corporation. Processor 310 may comprise at least one Qualcomm Snapdragon and/or Intel Core processor. Processor 310 may comprise at least one application-specific integrated circuit, ASIC. Processor 310 may comprise at least one field-programmable gate array, FPGA. Processor 310 may be means for performing method steps in device 300. Processor 310 may be configured, at least in part by computer instructions, to perform actions.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to request measurements or visualize measurement data, where applicable.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

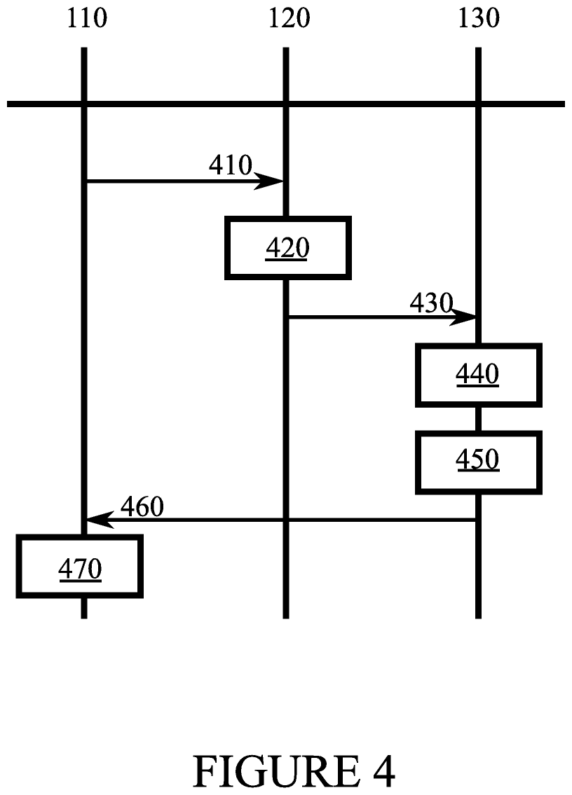

FIG. 4 illustrates signalling in accordance with at least some embodiments of the present invention. On the vertical axes are disposed, from the left, device 110, server 120 and measurement device 130 of FIGS. 1 and 2. Time advances from the top toward the bottom.

Phase 410 comprises device 110 requesting a measurement by transmitting a measurement request to server 120. This request may comprise, for example, a measurement specification, an identifier of measurement device 130, payment information and a public key of device 110. The payment information may comprise, for example, a cryptocurrency account number and credential of device 110. The signalling of phase 410 may take place in an electronic payment transaction protocol context, for example. In phase 420, server 120 may validate the payment transaction, for example by referring to a separate payment processor or a bank computer system. In case the validation is successful, processing advances to phase 430 wherein server 120 provides a measurement specification to measurement device 130, along with the public key of device 110.

In phase 440, measurement device 130 generates a symmetric key, and in phase 450 measurement device 130 encrypts measurement data matching the measurement specification with the symmetric key, and encrypts the symmetric key with the public key of device 110. Measurement device 130 provides the encrypted measurement data to device 110 in phase 460, the encrypted data being provided with the encrypted symmetric key. In phase 470, device 110 decrypts first the symmetric key, using the private key of device 110, and then the measurement data itself, using the decrypted symmetric key. Note, that while arrow 460 proceeds from measurement device 130 to device 110, this providing may alternatively proceed from measurement device 130 to a storage service, such as a cloud storage service, where device 110 may then download the encrypted data from.

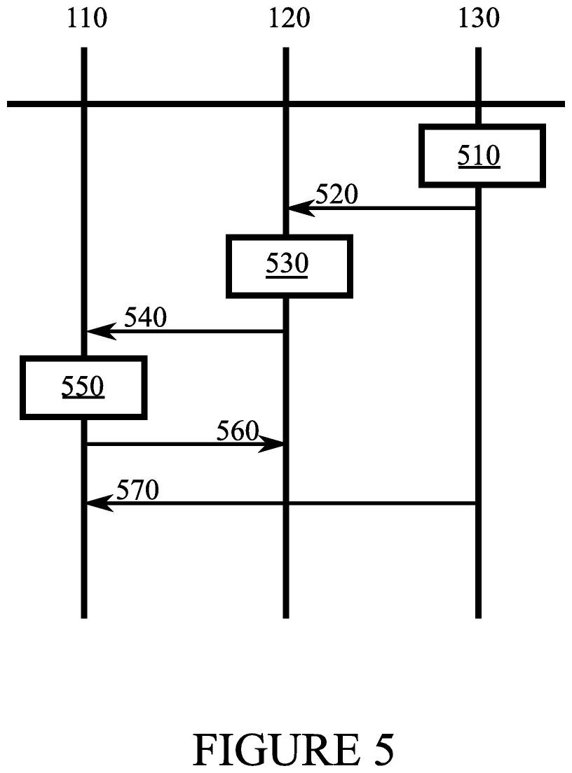

FIG. 5 illustrates signalling in accordance with at least some embodiments of the present invention. The vertical axes correspond to those of FIG. 4. The phases of FIG. 5 may occur after those of FIG. 4, for example.

In phase 510, measurement device 130 determines that a quota of measurements, associated with a payment amount, has been delivered to device 110, and responsively, in phase 520, server 120 is informed of this. Server 120 may then finalize a payment transaction, phase 530, and inform device 110 of the end of measurements due to exhaustion of paid quota, phase 540.

In phase 550, a determination is reached in device 110 whether additional measurements are desired, and if this is the case, additional measurements are requested, phase 560. The requesting of phase 560 may essentially resemble the requesting described in connection with FIG. 4, which is omitted in FIG. 5 for the sake of simplicity. In phase 570 the additional measurements are delivered, in encrypted form, to device 110.

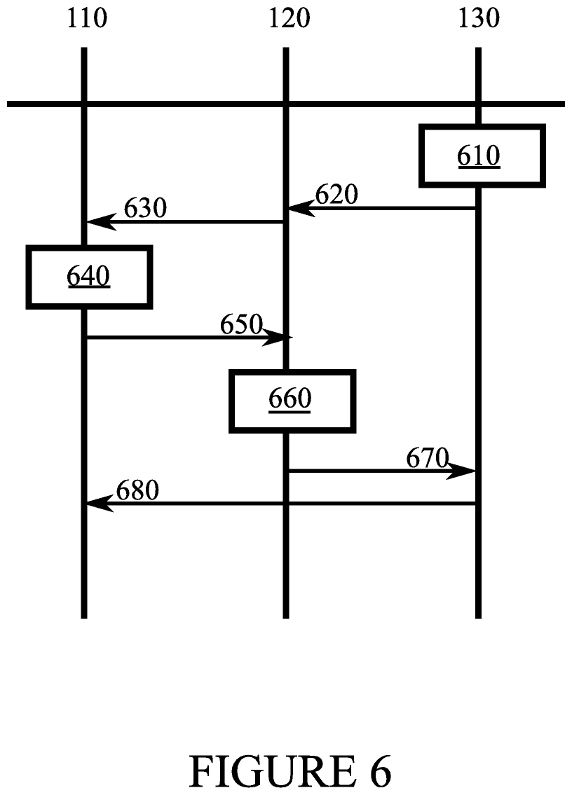

FIG. 6 illustrates signalling in accordance with at least some embodiments of the present invention. The vertical axes correspond to those of FIG. 5, and the process of FIG. 6 is an optimization of the process of FIG. 5.

In phase 610, measurement device 130 determines that a quota of measurements, associated with a payment amount, nears its end, for example, by determining that less than a threshold of the quota is remaining. Responsively, in phase 620 measurement device 130 indicates to server 120 the quota is nearing its end, and server 120, in phase 630, informs device 110 of this. In phase 640, device 110 performs a determination concerning whether additional measurements, beyond the quota, are needed, and if this is the case, in phase 650 device 110 requests for additional measurements. The requesting may resemble the requesting described above in connection with FIG. 4 and FIG. 1, for example.

In phase 660, server 120 may validate a new payment transaction, as described above, and responsive to the validation succeeding server 120 may transmit, in phase 670, a measurement instruction to measurement device 130, where a new quota is added to what remains of the previous, almost spent, measurement quota. Phase 680 represents continued provision of measurement data, in encrypted form, to device 110.

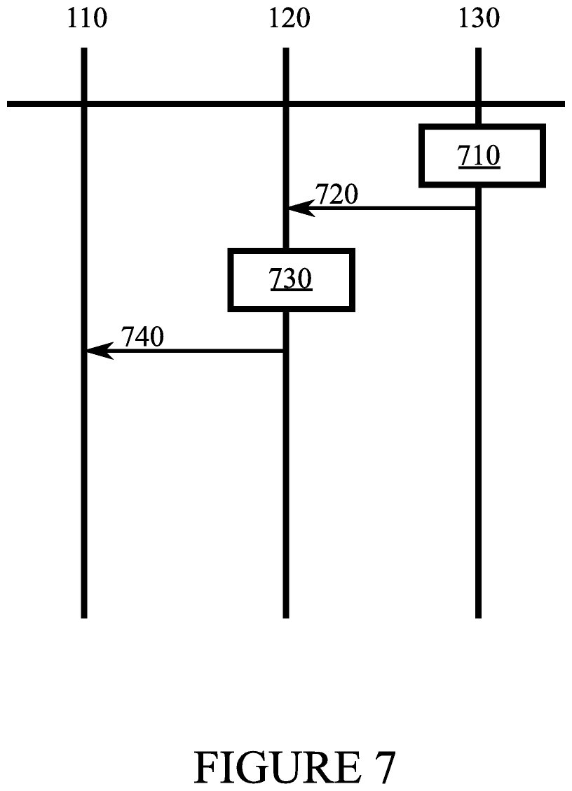

FIG. 7 illustrates signalling in accordance with at least some embodiments of the present invention. The vertical axes correspond to those of FIG. 6.

In phase 710 measurement device 130 stops performing measurements, for example responsive to all measurements requested in a measurement specification being complete. In phase 720, measurement device 130 indicates to server 120 that measurements have been stopped, and, optionally, a quantity of the completed measurements. Where server 120 has provided a measurement specification earlier to measurement device 130, measurement device 130 may provide a pointer to the measurement specification rather than the specification itself. In phase 730, server 120 may determine a price for the measurements performed. In phase 730, the determined price may also be charged. In phase 740 device 110 is informed the measurements have been completed, and also of the final cost.

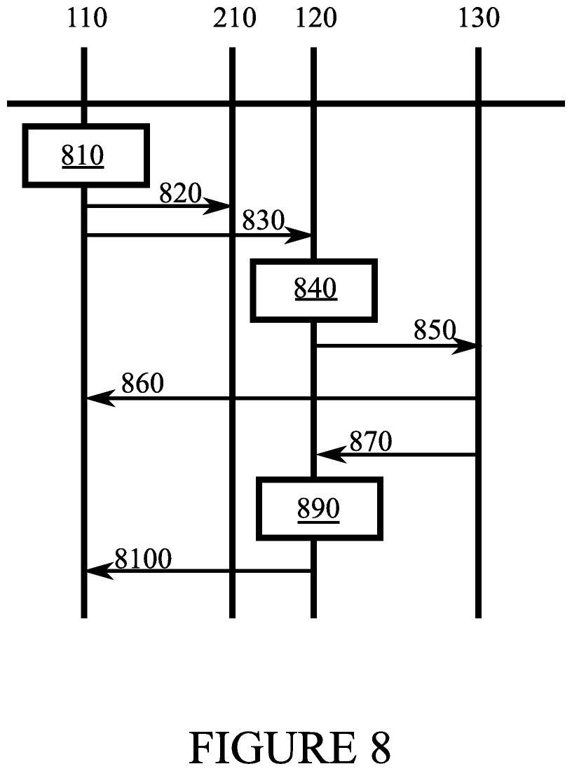

FIG. 8 illustrates signalling in accordance with at least some embodiments of the present invention. The vertical axes correspond to those of FIG. 7, except that payment processor 210 is also disposed among the vertical axes. Payment processor 210 has been described in connection with FIG. 2.

In phase 810 a hash value is obtained, using as input values a cryptocurrency account number of device 110, a cryptocurrency account number of measurement device 130 and a secret value. The secret value may be randomly generated in device 110, for example. A Bitcoin address is an example of a cryptocurrency account number.

In phase 820, a payment transaction is made between device 110 and payment processor 210, wherein the hash value is provided to payment processor 210. For example, the hash value may be provided in an OP RETURN operation. In phase 830, measurements are requested, by device 110, from server 120, wherein the requesting comprises providing to server 120 a public key of device 110 and the secret value. Phase 830 also comprises providing a pointer to the payment transaction of phase 820. Thus the public key is provided, in phase 830, in connection with providing payment information, the payment information here comprising the pointer to the payment transaction.

In phase 840, server 120 validates the payment transaction, with reference to payment processor 210. Server 120 also checks, that the secret value provided by device 110 is the correct one, that is, the secret value used in obtaining the hash value. Responsive to the payment transaction being validated and the secret value being determined to be correct, server 120 provides a measurement specification to measurement device 130, in phase 850. In phase 860, measurement device 130 provides to device 110 the requested measurement data, in encrypted form, as described above.

In phase 870, measurement device 130 indicates to server 120 the requested measurements have been completed, responsive to which, in phase 890, server 120 closes the payment transaction. In phase 8100 device 110 is advised concerning the end of measurements.

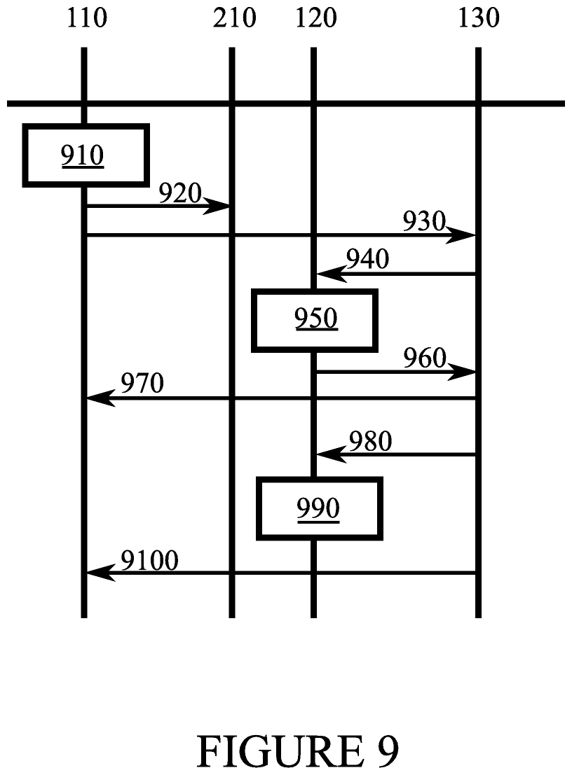

FIG. 9 illustrates signalling in accordance with at least some embodiments of the present invention. The vertical axes correspond to those of FIG. 8.

Phases 910 and 920 correspond to phases 810 and 820 of FIG. 8, respectively. In phase 930, device 110 transmits the measurement request to measurement device 130. The measurement request of phase 930 may be similar in content to the measurement request of phase 830 in FIG. 8.

In phase 940, measurement device 130 requests verification of the payment transaction from server 120 by transmitting a message that comprises the secret value and the pointer to the payment transaction. In phase 950 server 120 responsively validates the payment transaction, using the pointer and the secret value, as it does in FIG. 8, and then server 120 informs measurement device 130 of the result of the validation in phase 960.

In phase 970, measurement device 130 provides the requested measurement data to device 110, in encrypted form, as described above. Once the measurements described in the measurement request have been performed and the corresponding measurement data provided to device 110, measurement device 130 informs server 120 of the end of measurements, phase 980. Responsively, in phase 990, server 120 closes the payment transaction, and in phase 9100 device 110 is informed, by measurement device 130, of the end of measurements. Phase 9100 may alternatively proceed from server 120 to device 110.

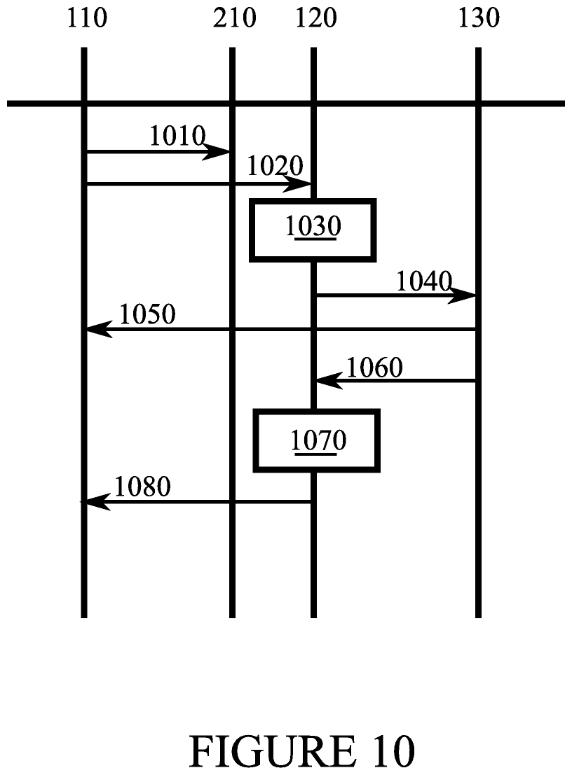

FIG. 10 illustrates signalling in accordance with at least some embodiments of the present invention. The vertical axes correspond to those of FIG. 9. The method illustrated in FIG. 10 resembles that of FIG. 8.

In phase 1010, device 110, knowing the identifier of measurement device 130, participates in a payment transaction with payment processor 210. In connection with the payment transaction, device 110 provides its payment information and its own public key to payment processor 210. The payment transaction may be made provisionally or into escrow or reserve, for example. In phase 1020, device 110 requests measurements from server 120, wherein the request of phase 1020 comprises a pointer to the payment transaction of phase 1010.

In phase 1030, the payment transaction is validated, and the public key of device 110 is fetched from payment processor 210 by server 120. Responsive to the validation indicating the payment transaction is successful, at least provisionally, server 120 requests measurements from measurement device 130, for example by providing a measurement specification, and the public key of device 110, in phase 1040. In phase 1050, measurement device 130 provides the requested measurements to device 110, encrypted using, at least partly, the public key of device 110, as described herein above.

In phase 1060, measurement device 130 informs server 120 the requested measurements have been completed, and responsively, in phase 1070, the payment transaction is closed and, in phase 1080, device 110 is informed concerning the end of measurements.

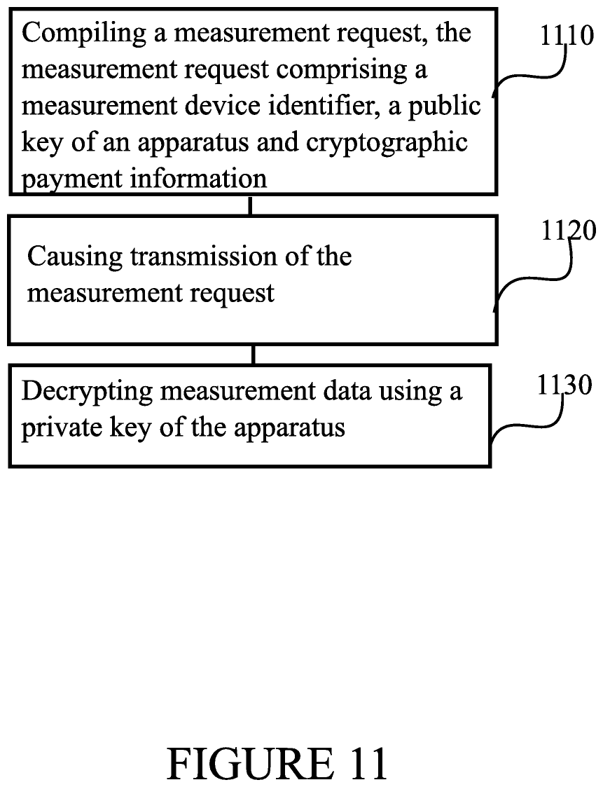

FIG. 11 is a flow graph of a method in accordance with at least some embodiments of the present invention. The phases of the illustrated method may be performed in device 110, or in a control device configured to control the functioning thereof, when implanted therein, for example.

Phase 1110 comprises compiling a measurement request, the measurement request comprising a measurement device identifier, a public key of an apparatus and cryptographic payment information. Phase 1120 comprises causing transmission of the measurement request. Finally, phase 1130 comprises decrypting measurement data using a private key of the apparatus.

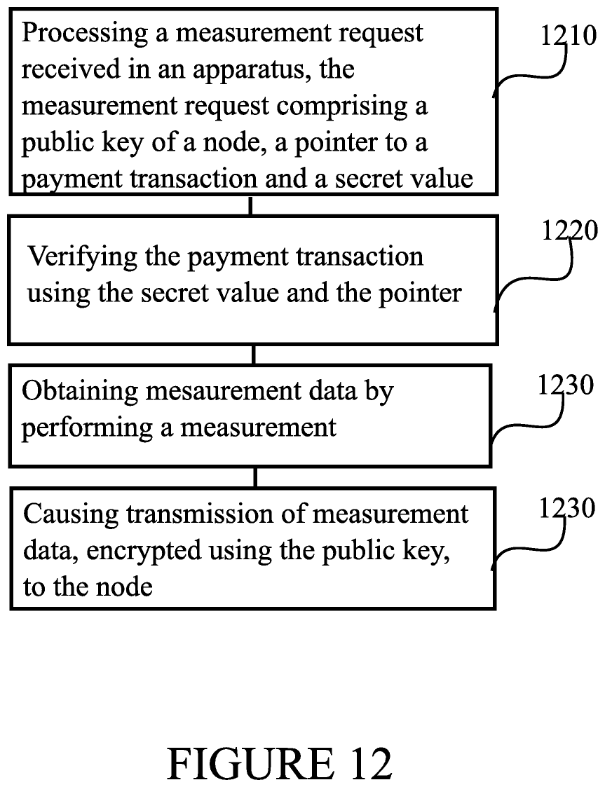

FIG. 12 is a flow graph of a method in accordance with at least some embodiments of the present invention. The phases of the illustrated method may be performed in server 120, measurement device 130, or in a control device configured to control the functioning thereof, when implanted therein.

Phase 1210 comprises processing a measurement request received in an apparatus, the measurement request comprising a public key of a node, a pointer to a payment transaction, and a secret value. Phase 1220 comprises verifying the payment transaction using the secret value and the pointer. Verifying may comprise performing phase 940 of the process of FIG. 9. Phase 1230 comprises obtaining measurement data by performing a measurement. Finally, phase 1240 comprises causing transmission of measurement data, encrypted using the public key, to the node.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in securing access to sensitive information.

### ACRONYMS LIST

3DES triple DES
AES advanced encryption standard
DES data encryption standard
HTTP hypertext transfer protocol
HTTPS HTTP over TLS
IP internet protocol

### IoT Internet of Things

LTE long term evolution
NFC near field communication
RSA Rivest-Shamir-Adleman crypto system
TLS transport layer security
WCDMA wideband code division multiple access
WiMAX Worldwide interoperability for microwave access
WLAN wireless local area network

1-31. (canceled)

32. An apparatus comprising:
at least one processing core, and
at least one memory including computer program code,
the at least one memory and the computer program code being configured to, with the at least one processing core, cause the apparatus at least to:
store a measurement device identifier;
compile a measurement request, the measurement request comprising the measurement device identifier, a public key of the apparatus and cryptographic payment information, to cause transmission of the measurement request, and to decrypt measurement data using a private key of the apparatus.

33. The apparatus according to claim 32, wherein the apparatus is further caused to decrypt the measurement data by decrypting a symmetric key using the private key, and then decrypting the measurement data using the symmetric key.

34. The apparatus according to claim 32, wherein the public key of the apparatus comprises at least one of a source address or public address associated with the apparatus.

35. The apparatus according to claim 33, wherein the apparatus is further caused to receive the symmetric key, in encrypted form, together with the measurement data.

36. The apparatus according to claim 32, wherein the apparatus is further caused to cause transmission of the measurement request to a payment processor distinct from the measurement device.

37. The apparatus according to claim 32, wherein the apparatus is further caused to cause transmission of the measurement request to the measurement device.

38. The apparatus according to claim 32, wherein the apparatus is further caused to receive the measurement data from the measurement device.

39. The apparatus according to claim 32, wherein the apparatus is further caused to obtain a hash value based at least partly on a secret value, the cryptographic payment information comprises a pointer to a payment transaction and wherein the measurement request comprises the secret value.

40. The apparatus according to claim 39, wherein the apparatus is further caused to inform a counterparty of the hash value in connection with participating in the payment transaction.

41. The apparatus according to claim 39, wherein the payment transaction comprises an escrow payment transaction, a reserve payment transaction or a provisional payment transaction.

42. An apparatus comprising at least one processing core, at least one memory including computer program code, the at least one memory and the computer program code being configured to, with the at least one processing core, cause the apparatus at least to:
process a measurement request received in the apparatus, the measurement request comprising a public key of a node, a pointer to a payment transaction, and a secret value;
verify the payment transaction using the secret value and the pointer;
obtain measurement data by performing a measurement, and
cause transmission of measurement data, encrypted using the public key, to the node.

43. The apparatus according to claim 42, wherein the apparatus is further caused to receive an indication concerning a quota of measurement data associated with the payment transaction, and to stop obtaining the measurement data responsive to the quota being used up.

44. The apparatus according to claim 43, wherein the apparatus is further caused to provide an indication concerning the quota being used up to a payment processor entity.

45. A method comprising:
compiling a measurement request, the measurement request comprising a measurement device identifier, a public key of an apparatus and cryptographic payment information;
causing transmission of the measurement request, and
decrypting measurement data using a private key of the apparatus.

46. The method according to claim 45, wherein decrypting the measurement data comprises decrypting a symmetric key using the private key, and then decrypting the measurement data using the symmetric key.

47. The method according to any of claim 45, wherein the public key of the apparatus comprises at least one of a source address or public address associated with the apparatus.

48. The method according to claim 46, further comprising receiving the symmetric key, in encrypted form, together with the measurement data.

49. The method according to claim 45, wherein the measurement request is caused to be transmitted to a payment processor distinct from the measurement device.

50. The method according to claim 45, wherein the measurement request is caused to be transmitted to the measurement device.

51. The method according to claim 45, further comprising receiving the measurement data from the measurement device.
